(19) United States
(12) Patent Application Publication
(10) Pub. No.: US 2024/0399307 A1
(43) Pub. Date: Dec. 5, 2024

(54) APPARATUS FOR TREATING HYDROGEN GAS

(71) Applicants: HYUNDAI MOTOR COMPANY, Seoul (KR); Kia Corporation, Seoul (KR)

(72) Inventors: Jin Young HEO, Hwaseong-si (KR); Se Kwon JUNG, Seoul (KR)

(73) Assignees: HYUNDAI MOTOR COMPANY, Seoul (KR); Kia Corporation, Seoul (KR)

(21) Appl. No.: 18/384,970

(22) Filed: Oct. 30, 2023

(30) Foreign Application Priority Data
Jun. 5, 2023 (KR) 10-2023-0072317

(51) Int. Cl. B01D 53/86; B01D 53/88; H01M 8/04082; H01M 8/0662

(52) U.S. Cl. CPC B01D 53/8671; B01D 53/885; B01D 2251/11; B01D 2257/108; B01D 2258/0208; H01M 8/04208; H01M 8/0662

(57) ABSTRACT

An apparatus for treating hydrogen gas includes an inner canning member configured to define a movement flow path through which the hydrogen gas flows, a catalyst provided in the internal canning member and configured to reduce a concentration of the hydrogen gas flowing along the internal canning member, and an external canning member surrounding a periphery of the internal canning member and configured to define an air guide flow path to guide air to an outlet end portion of the movement flow path along an external surface of the internal canning member, and a mixing flow path in which the hydrogen gas including passed through the catalyst is mixed with the air, obtaining an advantageous effect of effectively reducing a concentration of hydrogen gas.

### CROSS-REFERENCE TO RELATED APPLICATION

The present application claims priority to Korean Patent Application No. 10-2023-0072317 filed on Jun. 5, 2023, the entire contents of which is incorporated herein for all purposes by this reference.

### BACKGROUND OF THE PRESENT DISCLOSURE

### Field of the Present Disclosure

The present disclosure relates to an apparatus for treating hydrogen gas, and more particularly, to an apparatus for treating hydrogen gas, which is capable of effectively reducing a concentration of hydrogen gas.

### Description of Related Art

A fuel cell system refers to a system that produces electrical energy by a redox reaction between hydrogen and oxygen. Research and development have been consistently performed on the fuel cell system as an alternative capable of solving global environmental issues.

Recently, to increase an energy storage density per unit volume of fuel (e.g., hydrogen) used for the fuel cell system, various attempts have been made to store hydrogen in a liquid state (liquid hydrogen) at cryogenic temperatures (e.g., 20 K to 33 K) in a storage container and supply the fuel cell stack with the hydrogen (liquid hydrogen or gaseous hydrogen) stored in the storage container.

Meanwhile, when heat is introduced into the storage container, hydrogen is evaporated (liquid hydrogen→gaseous hydrogen), and pressure in the storage container increases (a risk of explosion increases). When the pressure in the storage container increases to a predetermined pressure or higher, it is necessary to reduce the pressure in the storage container by discharging hydrogen. An emission concentration of hydrogen is regulated to be a predetermined concentration or lower by law.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an apparatus for treating hydrogen gas, which is configured for effectively reducing a concentration of hydrogen gas.

The present disclosure has been made in an effort to effectively reduce a concentration of hydrogen gas discharged from a storage container that stores liquid hydrogen.

Among other things, the present disclosure has been made in an effort to passively treat hydrogen gas (reduce a concentration thereof) without consuming separate electric power to reduce a concentration of hydrogen gas.

The present disclosure has also been made in an effort to simplify a structure and improve spatial utilization and a degree of design freedom.

The present disclosure has also been made in an effort to suppress overheating of a hydrogen gas reduction device and improve safety and reliability.

The objects to be achieved by the exemplary embodiments are not limited to the above-mentioned objects, but also include objects or effects which may be understood from the solutions or embodiments described below.

An exemplary embodiment of the present disclosure provides an apparatus for treating hydrogen gas, the apparatus including: an internal canning member configured to define a movement flow path through which the hydrogen gas flows; a catalyst provided in the internal canning member and configured to reduce a concentration of the hydrogen gas flowing along the internal canning member; and an external canning member surrounding a periphery of the internal canning member and configured to define an air guide flow path to guide air to an outlet end portion of the movement flow path along an external surface of the internal canning member, and a mixing flow path in which the hydrogen gas having passed through the catalyst is mixed with the air.

According to the exemplary embodiment of the present disclosure, the external canning member may include: a main body portion surrounding the periphery of the internal canning member and configured to define the air guide flow path therein; and a mixing portion formed at an end portion of the main body portion adjacent to the outlet end portion and including a cross-sectional area that decreases from a first end portion to a second end portion of the mixing portion, the mixing portion being configured to define the mixing flow path.

According to the exemplary embodiment of the present disclosure, the apparatus may include a heat transfer member connecting the catalyst and the internal canning member so that the catalyst and the internal canning member transfer heat to each other.

According to the exemplary embodiment of the present disclosure, the heat transfer member may be fixed to the internal canning member, and the catalyst may be supported by the heat transfer member.

According to the exemplary embodiment of the present disclosure, the apparatus may include: an accommodation groove provided in the catalyst, in which the heat transfer member is accommodated in the accommodation groove.

According to the exemplary embodiment of the present disclosure, the heat transfer member may be provided as a plurality of heat transfer members spaced from one another radially with respect to a center portion of the catalyst.

According to the exemplary embodiment of the present disclosure, the heat transfer member may be exposed to the air guide flow path to come into contact with the air, and the air may flow to the mixing flow path along the air guide flow path by convection made when the air is heated by heat transferred from the catalyst to the heat transfer member.

According to the exemplary embodiment of the present disclosure, the apparatus may include a spray portion provided at an upstream side of the catalyst and configured to spray the hydrogen gas toward the catalyst.

According to the exemplary embodiment of the present disclosure, the air may be introduced into the movement flow path by at least one of inertia of the hydrogen gas moved by the spray portion and convection made by heat generated from the catalyst.

According to the exemplary embodiment of the present disclosure, the spray portion may include a plurality of spray nozzles spaced from one another and configured to spray the hydrogen gas.

According to the exemplary embodiment of the present disclosure, the spray portion may be connected to a storage container configured to store liquid hydrogen, and the spray portion may spray the hydrogen gas vaporized from the liquid hydrogen.

According to the exemplary embodiment of the present disclosure, the apparatus may include: a cooling jacket provided on the internal canning member to be in contact with the catalyst and configured to circulate a cooling medium for cooling the catalyst.

According to the exemplary embodiment of the present disclosure, the cooling jacket may be exposed to the air guide flow path to come into contact with the air, and the air may flow to the mixing flow path along the air guide flow path by convection made when the air is heated by heat transferred from the catalyst to the cooling jacket.

According to the exemplary embodiment of the present disclosure, the cooling medium may include condensate water discharged from a fuel cell stack.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view for explaining an apparatus for treating hydrogen gas according to an exemplary embodiment of the present disclosure.

FIG. 2 is a view for explaining a modified example of a spray portion of the apparatus for treating hydrogen gas according to the exemplary embodiment of the present disclosure.

FIG. 3 is a view for explaining a heat transfer member of the apparatus for treating hydrogen gas according to the exemplary embodiment of the present disclosure.

FIG. 4 is a view for explaining a cooling jacket of the apparatus for treating hydrogen gas according to the exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings.

However, the technical spirit of the present disclosure is not limited to various exemplary embodiments described herein but may be implemented in various different forms. One or more of the constituent elements in the exemplary embodiments of the present disclosure may be selectively combined and substituted for use within the scope of the technical spirit of the present disclosure.

Furthermore, unless otherwise specifically and explicitly defined and stated, the terms (including technical and scientific terms) used in the exemplary embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

Furthermore, the terms used in the exemplary embodiments of the present disclosure are for explaining the embodiments, not for limiting the present disclosure.

In the present specification, unless particularly stated otherwise, a singular form may also include a plural form. The expression “at least one (or one or more) of A, B, and C” may include one or more of all combinations that may be made by combining A, B, and C.

Furthermore, the terms such as first, second, A, B, (a), and (b) may be used to describe constituent elements of the exemplary embodiments of the present disclosure.

These terms are used only for discriminating one constituent element from another constituent element, and the nature, the sequences, or the orders of the constituent elements are not limited by the terms.

Furthermore, when one constituent element is described as being ‘connected’, ‘coupled’, or ‘attached’ to another constituent element, one constituent element may be connected, coupled, or attached directly to another constituent element or connected, coupled, or attached to another constituent element through yet another constituent element interposed therebetween.

Furthermore, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

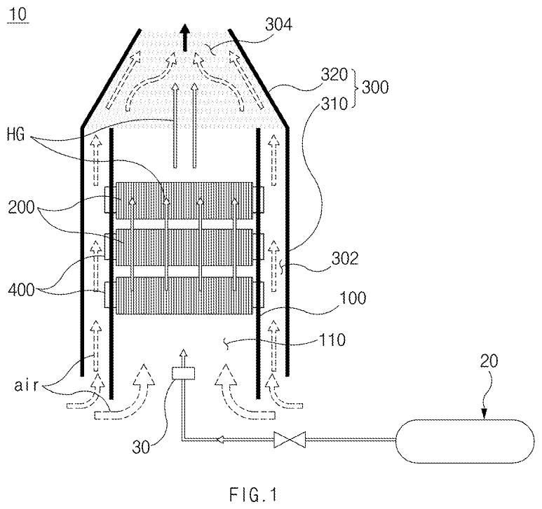

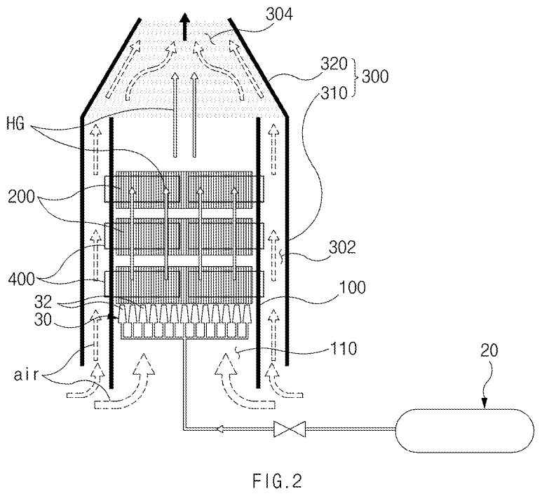

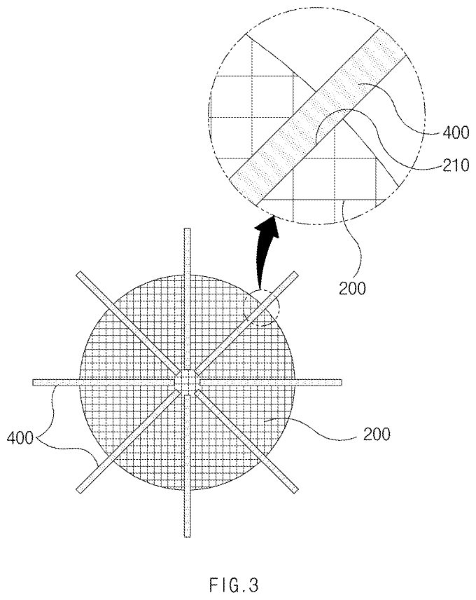

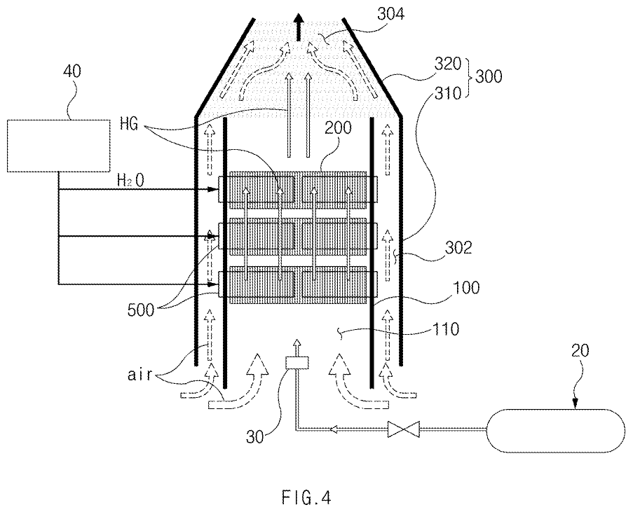

With reference to FIG. 1, FIG. 2, FIG. 3, and FIG. 4, an apparatus 10 for treating hydrogen gas according to an exemplary embodiment of the present disclosure includes an internal canning member 100 configured to define a movement flow path 110 in which hydrogen gas HG flows, catalysts 200 provided in the internal canning member 100 and configured to reduce a concentration of the hydrogen gas HG flowing along the internal canning member 100, and an external canning member 300 configured to surround a periphery of the internal canning member 100 and to define an air guide flow path 302 configured to guide air to an outlet end portion of the movement flow path 110 along an external surface of the internal canning member 100 and define a mixing flow path 304 configured to mix air with the hydrogen gas HG having passed through the catalysts 200.

This is to effectively reduce the concentration of the hydrogen gas HG discharged from an object.

That is, a risk of explosion increases when the concentration of hydrogen gas (hydrogen concentration) discharged from the object increases to a predetermined concentration or higher. Therefore, an emission concentration of hydrogen gas is regulated to be a predetermined concentration or lower by law.

Generally, there has been provided a method of mixing air with hydrogen gas discharged from an object and discharging the mixture. However, a space (route), in which hydrogen gas and air are mixed, needs to be sufficiently ensured to sufficiently dilute hydrogen gas discharged from the object. Furthermore, a mixing chamber including a large capacity needs to be used to effectively mix air and hydrogen gas, which inevitably complicates the structure and degrades a degree of design freedom and spatial utilization.

Moreover, generally, a separate fan needs to be used to forcibly supply air for reducing a concentration of hydrogen gas, which complicates the structure and degrades electric power efficiency.

In contrast, in the exemplary embodiment of the present disclosure, the hydrogen gas HG discharged from the object is treated while passing through the catalysts 200 (a hydrogen concentration decreases). Therefore, it is possible to obtain an advantageous effect of effectively reducing a hydrogen concentration of the hydrogen gas HG discharged from the object and simplifying the structure.

Among other things, in the exemplary embodiment of the present disclosure, after the hydrogen gas HG discharged from the object is treated while passing through the catalysts 200 (the hydrogen concentration decreases), the hydrogen gas HG is mixed with (diluted by) air again, and then the mixture is discharged. Therefore, it is possible to sufficiently reduce the concentration of the hydrogen gas HG without using a separate mixing chamber including a large capacity. Therefore, it is possible to obtain an advantageous effect of ensuring hydrogen concentration reduction performance, further miniaturizing the apparatus 10 for treating hydrogen gas, simplifying the structure, and improving the degree of freedom of design and spatial utilization.

Moreover, in the exemplary embodiment of the present disclosure, air is passively supplied to the apparatus 10 for treating hydrogen gas (supplied to the catalyst or the air guide flow path) based on the inertia of the flowing hydrogen gas HG, and the convection made by heat generated from the catalyst 200. Therefore, no separate fan for forcibly supplying air is needed. Therefore, it is possible to obtain an advantageous effect of simplifying the structure, improving the degree of design freedom and spatial utilization, and minimizing the electric power consumption.

For reference, the apparatus 10 for treating hydrogen gas according to the exemplary embodiment of the present disclosure may be used to treat the hydrogen gas HG (reduce a concentration of the hydrogen gas HG) discharged from various objects in accordance with required conditions and design specifications. The present disclosure is not restricted or limited by the type and properties of the object.

For example, the apparatus 10 for treating hydrogen gas according to the exemplary embodiment of the present disclosure may be used to treat the hydrogen gas HG discharged from a storage container 20 that stores fuel (e.g., liquid hydrogen) used for mobility vehicles such as fuel cell electric vehicles (e.g., passenger vehicles or commercial vehicles), ships, and aircraft to which a fuel cell system is applied.

The storage container 20 is provided to store hydrogen in a liquid state (liquid hydrogen which is a cryogenic fluid) used for a fuel cell stack 40 (see FIG. 4).

The storage container 20 may have various structures configured for storing the liquid hydrogen (e.g., at −253° C. based on atmospheric pressure). The present disclosure is not restricted or limited by the type and structure of the storage container 20.

For example, the storage container 20 may include an internal container having an accommodation space configured to accommodate a cryogenic fluid, an external container configured to surround a periphery of the internal container, and a vacuum thermal insulation layer defined between the internal container and the external container.

A pressure relief valve (PRV) may be provided in a discharge line of the storage container 20. When pressure in the storage container 20 exceeds a preset reference pressure, hydrogen (hydrogen gas evaporated from liquid hydrogen) in the storage container 20 may pass through the discharge line and the pressure relief valve and be then discharged to the outside of the storage container 20.

The internal canning member 100 is configured to define the movement flow path 110 through which the hydrogen gas HG (hydrogen gas discharged from the storage container) flows.

The internal canning member 100 may have various structures configured for defining the movement flow path 110. The present disclosure is not restricted or limited by the structure and shape of the internal canning member 100.

For example, the internal canning member 100 may have a hollow cylindrical shape including an approximately circular cross-section. The movement flow path 110 including a straight shape may be defined in a gravitational direction (upward/downward direction) in the internal canning member 100.

The hydrogen gas HG discharged from the storage container 20 may be introduced through an inlet end portion of the movement flow path 110 (a lower end portion of the internal canning member 100 based on FIG. 1) and then discharged through an outlet end portion of the movement flow path 110 (an upper end portion of the internal canning member 100 based on FIG. 1).

In the exemplary embodiment of the present disclosure illustrated and described above, the example has been described in which the movement flow path 110 including a straight shape is provided in the internal canning member 100. However, according to another exemplary embodiment of the present disclosure, the movement flow path may include a curved shape or other shapes.

The catalyst 200 is provided in the internal canning member 100 and configured to reduce a concentration of the hydrogen gas HG flowing along the movement flow path 110 of the internal canning member 100.

Hereinafter, an example will be described in which three catalysts 200 are provided in the internal canning member 100 and spaced from one another in the upward/downward direction thereof. According to another exemplary embodiment of the present disclosure, two or fewer catalysts or four or more catalysts may be provided in the internal canning member. The present disclosure is not restricted or limited by the number of catalysts.

Various catalysts 200 configured for treating the hydrogen gas HG (reducing a hydrogen concentration of hydrogen gas) may be used as the catalyst 200. The present disclosure is not restricted or limited by the type and properties of the catalyst 200.

For example, an oxidation catalyst, which may reduce a concentration of the hydrogen gas HG by generating an oxidation reaction of the hydrogen gas HG, may be used as the catalyst 200.

The oxidation reaction of the hydrogen gas HG passing through the catalyst 200 may satisfy Chemical Equation 1 below.

2H₂(g)+O₂(g)→2H₂O(g) [Chemical Equation 1]

The external canning member 300 is configured to surround a periphery of the internal canning member 100 and to define the air guide flow path 302 configured to guide air to the outlet end portion of the movement flow path 110 along the external surface of the internal canning member 100, and the mixing flow path 304 configured to mix air with the hydrogen gas HG passing through the catalysts 200.

In the instant case, the air guide flow path 302 may be defined as a space that guides outside air, which is provided at a lower side of the external canning member 300, to the outlet end portion of the movement flow path 110. The mixing flow path 304 may be defined as a space in which the hydrogen gas HG passing through the catalysts 200 is mixed with air supplied along the air guide flow path 302.

The external canning member 300 may have various structures configured for defining the air guide flow path 302 and the mixing flow path 304. The present disclosure is not restricted or limited by the structure and shape of the external canning member 300.

According to the exemplary embodiment of the present disclosure, the external canning member 300 may include a main body portion 310 configured to surround the periphery of the internal canning member 100 and to define the air guide flow path 302, and a mixing portion 320 provided at an end portion of the main body portion 310 adjacent to the outlet end portion of the movement flow path 110 and including a cross-sectional area that decreases from a first end portion to a second end portion of the mixing portion, the mixing portion 320 being configured to define the mixing flow path 304.

For example, the main body portion 310 may include a hollow cylindrical shape having a larger diameter than the internal canning member 100 and be disposed coaxially with the internal canning member 100. The air guide flow path 302 including an approximately annular shape may be defined between the external surface of the internal canning member 100 and an internal surface of the main body portion 310, and the air may flow through the air guide flow path 302.

The mixing portion 320 may have an approximately truncated conical shape including a cross-sectional area that gradually decreases from one end portion (the lower end portion based on FIG. 1) to the other end portion (the upper end portion based on FIG. 1). The hydrogen gas HG, which has passed through the catalysts 200, (e.g., unreacted hydrogen gas which has not reacted with the catalysts), and the air supplied along the air guide flow path 302 may be mixed in the mixing flow path 304 defined in the mixing portion 320, and then the mixture may be discharged to the outside of the external canning member 300.

In the exemplary embodiment of the present disclosure illustrated and described above, the example has been described in which the internal canning member 100 and the main body portion 310 are coaxially disposed. However, according to another exemplary embodiment of the present disclosure, the internal canning member and the main body portion may be disposed non-coaxially.

Furthermore, in the exemplary embodiment of the present disclosure, the example has been described in which the air guide flow path 302 is provided entirely between the internal canning member 100 and the main body portion 310. However, according to another exemplary embodiment of the present disclosure, the air guide flow path may be provided only in a partial region between the internal canning member and the main body portion (a partial region defined in a circumferential direction of the internal canning member).

With reference to FIG. 1, according to the exemplary embodiment of the present disclosure, the apparatus 10 for treating hydrogen gas may include heat transfer members 400 configured to connect the catalysts 200 and the internal canning member 100 so that the catalysts 200 and the internal canning member 100 may transfer heat to one another.

In the instant case, the configuration in which the heat transfer member 400 connects the catalyst 200 and the internal canning member 100 so that the catalyst 200 and the internal canning member 100 may transfer heat to each other may be understood as a configuration in which heat generated from the catalyst 200 may be transferred (conducted) to the internal canning member 100 by the heat transfer member 400.

The heat transfer member 400 may have various structures configured for transferring (conducting) heat (reaction heat), which is generated by the oxidation reaction of the catalyst 200, to the internal canning member 100. The present disclosure is not restricted or limited by the structure and shape of the heat transfer member 400.

For example, the heat transfer member 400 may include an approximately annular shape that continuously surrounds a periphery of the catalyst 200. One end portion of the heat transfer member 400 may be connected to (be in contact with) a lateral surface of the catalyst 200, and the other end portion of the heat transfer member 400 may be connected to (be in contact with) the internal canning member 100.

The heat transfer member 400 may be made of a typical heat transfer material (e.g., metal) having high thermal conductivity. The present disclosure is not restricted or limited by the material and properties of the heat transfer member 400.

As described above, in the exemplary embodiment of the present disclosure, the heat (reaction heat) generated from the catalyst 200 is transferred to the internal canning member 100 by the heat transfer member 400, which may prevent the catalyst 200 from being overheated by the oxidation reaction. Therefore, it is possible to obtain an advantageous effect of improving the durability and lifespan of the catalyst 200.

According to the exemplary embodiment of the present disclosure, the heat transfer member 400 may be fixed to the internal canning member 100, and the catalyst 200 may be supported by the heat transfer member 400.

For example, the heat transfer member 400 may be inserted into a through-hole provided in the internal canning member 100 so that the heat transfer member 400 may be integrally fixed to the internal canning member (e.g., fixed by welding), and the catalyst 200 may be supported on the internal canning member 100 by the heat transfer member 400.

As described above, in the exemplary embodiment of the present disclosure, the heat transfer member 400 may not only serve as a conductor for transferring heat, which is generated from the catalyst 200, to the internal canning member 100, but also serve as a support body for supporting the catalyst 200 so that a separate support member for supporting the catalyst 200 may be excluded. Therefore, it is possible to obtain an advantageous effect of simplifying the structure and improving the spatial utilization and the degree of design freedom.

According to another exemplary embodiment of the present disclosure, a separate support body for supporting the catalyst on the internal canning member may be provided, and the heat transfer member may be configured to only serve as a conductor for transferring heat, which is generated from the catalyst, to the internal canning member.

According to the exemplary embodiment of the present disclosure, the heat transfer member 400 may be exposed to the air guide flow path 302 to come into contact with air. The air may flow to the mixing flow path 304 along the air guide flow path 302 (the air flows upward based on FIG. 1) based on convection made when the air is heated by heat transferred from the catalyst 200 to the heat transfer member 400.

For example, one end portion of the heat transfer member 400 may penetrate the internal canning member 100 and then protrude to the inside of the air guide flow path 302 (protrude from the external surface of the internal canning member). The air in the air guide flow path 302 is heated by heat transferred from the catalyst 200 to the heat transfer member 400 so that the convection may occur (the air may flow upward toward the mixing flow path).

As described above, in the exemplary embodiment of the present disclosure, the convection of air introduced into the air guide flow path 302 (the upward flow of heated air) may be made by heat transferred from the catalyst 200 to the heat transfer member 400. Therefore, the air may be passively supplied to the mixing flow path 304 (the outlet end portion of the movement flow path) without using a separate fan.

With reference to FIG. 2 and FIG. 3, according to another exemplary embodiment of the present disclosure, the apparatus 10 for treating hydrogen gas may include accommodation grooves 210 provided in the catalyst 200, and the heat transfer members 400 may be accommodated in the accommodation grooves 210.

For example, the accommodation groove 210 may include a straight shape that traverses the catalyst 200 from an approximately central portion to an edge portion of the catalyst 200 in a radial direction of the catalyst 200. The heat transfer member 400 may include a straight plate shape corresponding to the accommodation groove 210.

As described above, in the exemplary embodiment of the present disclosure, the accommodation groove 210 is provided in the catalyst 200, and the heat transfer member 400 is accommodated in the accommodation groove 210 so that a heat transfer area (contact area) between the catalyst 200 and the heat transfer member 400 may be sufficiently ensured. Therefore, it is possible to obtain an advantageous effect of improving the cooling performance of the catalyst 200 and facilitating the convection of the air flowing along the air guide flow path 302.

Furthermore, in the exemplary embodiment of the present disclosure, the heat transfer member 400 is accommodated in the accommodation groove 210 provided adjacent to the center portion of the catalyst 200, which makes it possible to cool not only the edge portion of the catalyst 200 but also the center portion of the catalyst 200.

The heat transfer member 400 may be provided as a plurality of heat transfer members 400 spaced from one another radially based on the center portion of the catalyst 200.

For example, the catalyst 200 may include a plurality of (e.g., eight) accommodation grooves 210 spaced from one another radially based on the center portion of the catalyst 200. The plurality of heat transfer members 400 may be independently accommodated in the plurality of accommodation grooves 210.

With reference to FIG. 1, according to the exemplary embodiment of the present disclosure, the apparatus 10 for treating hydrogen gas may include a spray portion 30 provided at an upstream side of the catalyst 200 (provided below the catalyst based on FIG. 1) and configured to spray the hydrogen gas HG toward the catalyst 200.

The spray portion 30 may be provided at the end portion of the discharge line of the storage container 20 and spray the hydrogen gas HG (hydrogen gas vaporized from liquid hydrogen in the storage container) toward the catalyst 200 at predetermined pressure.

Various spray devices configured for spraying the hydrogen gas HG at predetermined pressure may be used as the spray portion 30. The present disclosure is not restricted or limited by the type and structure of the spray portion 30.

For reference, the pressure for spraying the hydrogen gas HG by the spray portion 30 may be variously changed in accordance with required conditions and design specifications. The present disclosure is not restricted or limited by the pressure for spraying the hydrogen gas HG.

As described above, in the exemplary embodiment of the present disclosure, the hydrogen gas HG is sprayed toward the catalyst 200 at the predetermined pressure by the spray portion 30. The ambient air provided at the lower side of the internal canning member 100, together with the hydrogen gas HG, may be passively supplied to the movement flow path 110 by the inertia of the flowing hydrogen gas HG.

Furthermore, according to the exemplary embodiment of the present disclosure, the ambient air provided at the lower side of the internal canning member 100 may be passively supplied to (drawn in into) the movement flow path 110 by the convection made by the oxidation reaction (exothermic reaction) of the hydrogen gas HG passing through the catalyst 200.

With reference to FIG. 2, according to another exemplary embodiment of the present disclosure, the spray portion 30 may include a plurality of spray nozzles 32 spaced from one another and configured to spray the hydrogen gas HG.

For example, the plurality of spray nozzles 32 may be connected in parallel to the end portion of the discharge line of the storage container 20 so that the plurality of spray nozzles 32 defines a shape corresponding to the catalyst 200.

As described above, in the exemplary embodiment of the present disclosure, the spray portion 30 includes the plurality of spray nozzles 32 spaced from one another, uniformly spraying the hydrogen gas HG to an entire region of the catalyst 200 and inducing a uniform oxidation reaction of the hydrogen gas HG in the entire region of the catalyst 200.

Meanwhile, in the exemplary embodiment of the present disclosure illustrated and described above, the example has been described in which the heat generated from the catalyst 200 is transferred to the internal canning member 100 by the heat transfer member 400, and the catalyst 200 is cooled. However, according to another exemplary embodiment of the present disclosure, the catalyst may be cooled by use of a cooling jacket.

With reference to FIG. 4, according to the exemplary embodiment of the present disclosure, the apparatus 10 for treating hydrogen gas may include cooling jackets 500 provided on the internal canning member 100 to be in contact with the catalysts 200 so that a cooling medium for cooling the catalysts 200 circulates through the cooling jackets 500.

The cooling jacket 500 may have various structures configured for circulating the cooling medium therethrough and being in contact with the catalyst 200 (to conduct heat). The present disclosure is not restricted or limited by the structure of the cooling jacket 500.

For example, the catalyst 200 may include the accommodation grooves 210 (see FIG. 3) that each include an approximately straight shape and traverse the catalyst 200 from the approximately central portion to the edge portion of the catalyst 200 in the radial direction of the catalyst 200. The cooling jackets 500 may be accommodated in the accommodation grooves 210.

According to the exemplary embodiment of the present disclosure, the cooling jacket 500 may be exposed to the air guide flow path 302 to come into contact with air. The air may flow to the mixing flow path 304 along the air guide flow path 302 (the air flows upward based on FIG. 4) based on convection made when the air is heated by heat transferred from the catalyst 200 to the cooling jacket 500.

For example, one end portion of the cooling jacket 500 may penetrate the internal canning member 100 and then protrude to the inside of the air guide flow path 302 (protrude from the external surface of the internal canning member). The air in the air guide flow path 302 is heated by heat transferred from the catalyst 200 to the cooling jacket 500 so that the convection may occur (the air may flow upward toward the mixing flow path).

Various media may be used as the cooling medium, which circulates through the cooling jacket 500, in accordance with required conditions and design specifications. The present disclosure is not restricted or limited by the type and properties of the cooling medium.

According to the exemplary embodiment of the present disclosure, condensate water (H₂O) discharged from the fuel cell stack 40 may be used as the cooling medium, and the catalyst 200 may be cooled by use of sensible heat and latent heat of the cooling medium (condensate water).

As described above, according to the exemplary embodiment of the present disclosure described above, it is possible to effectively reduce a concentration of hydrogen gas.

According to the exemplary embodiment of the present disclosure, it is possible to effectively reduce a concentration of hydrogen gas discharged from the storage container that stores liquid hydrogen.

Among other things, according to the exemplary embodiment of the present disclosure, it is possible to passively treat hydrogen gas (reduce a concentration thereof) without consuming separate electric power to reduce a concentration of hydrogen gas.

Furthermore, according to the exemplary embodiment of the present disclosure, it is possible to obtain an advantageous effect of simplifying the structure and improving the spatial utilization and the degree of design freedom.

Furthermore, according to the exemplary embodiment of the present disclosure, it is possible to obtain an advantageous effect of improving the safety and reliability of the hydrogen gas reduction device while inhibiting the hydrogen gas reduction device from being overheated.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

In the present specification, a singular expression includes the plural form unless the context clearly dictates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An apparatus for treating hydrogen gas, the apparatus comprising:
an internal canning member configured to define a movement flow path through which the hydrogen gas flows;
a catalyst provided in the internal canning member and configured to reduce a concentration of the hydrogen gas flowing along the internal canning member; and
an external canning member surrounding a periphery of the internal canning member and configured to define:
an air guide flow path to guide air to an outlet end portion of the movement flow path along an external surface of the internal canning member; and
a mixing flow path in which the hydrogen gas having passed through the catalyst is mixed with the air.

2. The apparatus of claim 1, wherein the external canning member includes:
a main body portion surrounding the periphery of the internal canning member and configured to define the air guide flow path therein; and
a mixing portion formed at an end portion of the main body portion adjacent to the outlet end portion and including a cross-sectional area that decreases from a first end portion to a second end portion of the mixing portion, the mixing portion being configured to define the mixing flow path.

3. The apparatus of claim 1, further including:
a heat transfer member connecting the catalyst and the internal canning member so that the catalyst and the internal canning member transfer heat to each other.

4. The apparatus of claim 3, wherein the heat transfer member is fixed to the internal canning member, and the catalyst is supported by the heat transfer member.

5. The apparatus of claim 4, wherein an end portion of the heat transfer member penetrates the internal canning member so that the heat transfer member is integrally fixed to the internal canning member.

6. The apparatus of claim 3, further including:
an accommodation groove provided in the catalyst,
wherein the heat transfer member is accommodated in the accommodation groove.

7. The apparatus of claim 3, wherein the heat transfer member is provided as a plurality of heat transfer members spaced from one another radially with respect to a center portion of the catalyst.

8. The apparatus of claim 3, wherein the heat transfer member is exposed to the air guide flow path to come into contact with the air, and the air flows to the mixing flow path along the air guide flow path by convection made in response that the air is heated by heat transferred from the catalyst to the heat transfer member.

9. The apparatus of claim 1, further including:
a spray portion provided at an upstream side of the catalyst and configured to spray the hydrogen gas toward the catalyst.

10. The apparatus of claim 9, wherein the air is introduced into the movement flow path by at least one of inertia of the hydrogen gas moved by the spray portion and convection made by heat generated from the catalyst.

11. The apparatus of claim 9, wherein the spray portion includes a plurality of spray nozzles spaced from one another and configured to spray the hydrogen gas.

12. The apparatus of claim 9, wherein the spray portion is connected to a storage container configured to store liquid hydrogen, and the spray portion sprays the hydrogen gas vaporized from the liquid hydrogen.

13. The apparatus of claim 1, further including:
a cooling jacket provided on the internal canning member to be in contact with the catalyst and configured to circulate a cooling medium for cooling the catalyst.

14. The apparatus of claim 13, wherein the cooling jacket is exposed to the air guide flow path to come into contact with the air, and the air flows to the mixing flow path along the air guide flow path by convection made in response that the air is heated by heat transferred from the catalyst to the cooling jacket.

15. The apparatus of claim 14, wherein a first end portion of the cooling jacket penetrates the internal canning member and then protrudes to the inside of the air guide flow path.

16. The apparatus of claim 13, wherein the cooling medium includes condensate water discharged from a fuel cell stack.

17. The apparatus of claim 1, wherein the catalyst includes an oxidation catalyst.
